(19) United States
(12) Patent Application Publication
(10) Pub. No.: US 2023/0400254 A1
(43) Pub. Date: Dec. 14, 2023

(54) FURNACE AND METHOD FOR OPERATING A FURNACE

(71) Applicant: INNOVATHERM PROF. DR. LEISENBERG GMBH + CO. KG, Butzbach (DE)

(72) Inventors: Frank Heinke, Weimar (DE); Detlef Maiwald, Moers (DE); Hans-Joerg Seifert, Jena (DE)

(21) Appl. No.: 18/033,965

(22) PCT Filed: Jul. 14, 2021
(86) PCT No.: PCT/EP2021/069571

§ 371 Date: Apr. 26, 2023

(30) Foreign Application Priority Data
Oct. 28, 2020 (DE) 10 2020 128 370.9

(51) Int. Cl. F27B 13/14; F27D 19/00

(52) U.S. Cl. CPC F27B 13/14; F27D 19/00; F27D 2019/0003; F27D 2019/0018; F27D 2019/0009

(57) ABSTRACT

A method and a control device for operating a furnace, in particular an anode furnace, formed by a plurality of heating channels and furnace chambers, the furnace chambers serving to receive carbonaceous products, in particular anodes, and the heating channels serving to control the temperature of the furnace chambers. The furnace includes at least one furnace unit that contains a heating zone, a fire zone and a cooling zone, which for their part are formed by at least one section that has furnace chambers. A suction ramp of the furnace unit is disposed in a section of the heating zone, and a burner ramp of the furnace unit is disposed in a section of the fire zone. Process air in the heating channels of the fire zone is heated by the burner ramp, and exhaust gas is suctioned from the heating channels of the heating zone by the suction ramp, while operation of the ramps is controlled by a control device of the furnace unit. The control device is used to determine respective enthalpy flow rates for at least two sections, where a difference of the respective enthalpy flow rates being determined as a characteristic, to compare such characteristic to a presupposed characteristic, and to determine a status of the furnace based on this comparison.

The invention relates to a method for operating a furnace, in particular an anode furnace, to a control device for a furnace, and to a furnace, the furnace being formed by a plurality of heating channels and furnace chambers, the furnace chambers serving to receive carbonaceous bodies, in particular anodes, and the heating channels serving to control the temperature of the furnace chambers, the furnace comprising at least one furnace unit, the furnace unit comprising a heating zone, a fire zone and a cooling zone, which for their part are formed by at least one section comprising furnace chambers, a suction ramp of the furnace unit being disposed in a section of the heating zone, and a burner ramp of the furnace unit being disposed in a section of the fire zone, process air in the heating channels of the fire zone being heated by means of the burner ramp, and exhaust gas being suctioned from the heating channels of the heating zone by means of the suction ramp, an operation of the ramps being controlled by means of a control device of the furnace unit.

The present method and the device are used in producing anodes which are needed for fused-salt electrolysis for producing primary aluminum, for example. These anodes or carbonaceous bodies are produced as what is referred to as green anodes or raw anodes from petroleum coke, to which pitch is added as a binder, in a molding process, said green anodes or raw anodes being sintered in an anode furnace or furnace after molding. This sintering process takes place in a heat treatment process which runs in a defined manner and in which the anodes undergo three phases, namely a heating phase, a sintering phase and a cooling phase. In said process, the raw anodes are located in a heating zone of a “fire” formed in a furnace composed of the heating zone, a fire zone and a cooling zone and are pre-heated by the exhaust heat of previously sintered carbonaceous bodies stemming from the fire zone before the pre-heated anodes are heated to the sintering temperature of about 1200° C. in the fire zone. According to the state of the art as known from WO 2013/044968 A1, for example, the different zones mentioned are defined by an alternately continuing arrangement of different units above furnace chambers or heating channels which receive the anodes.

The fire zone, which is disposed between the heating zone and the cooling zone, is defined by the fact that a burner mechanism or one or multiple so-called burner ramps is/are positioned above selected furnace chambers or heating channels. Anodes burned, i.e., heated to sintering temperature, immediately prior are located in the cooling zone. A fan or what is referred to as a cooling ramp, by means of which air is blown into the heating channels of the cooling zone, is disposed above the cooling zone. Through the heating channels, a suction mechanism or what is referred to as a suction ramp disposed above the heating zone transports the air from the cooling zone through the fire zone into the heating zone and, as waste gas or exhaust gas, from there through a waste gas cleaning system and discharges it to the environment. The suction ramp and the burner ramp form a furnace unit together with the cooling ramp and the heating channels.

The units mentioned are shifted along the heating channels in the direction of the raw anodes disposed in the furnace at regular time intervals. For instance, one furnace can comprise multiple furnace units whose units are shifted one after the other above the furnace chambers or the heating channels for subsequent heat treatment of the raw anodes or anodes. Anode furnaces of this kind, which can be configured as open or closed annular kilns in various architectures, present the problem that a volumetric flow rate of the process air or the exhaust gases transported through the furnace cannot be measured directly and only with much effort. For example, it should be ensured that a sufficient amount of oxygen for burning a fuel of the burner mechanism is available in the heating channels of the furnace.

Since the constructive design of the heating channels prevents direct measuring of the volumetric flow rate, the volumetric flow rate is determined indirectly by evaluating pressure and temperature measurements at the heating channels and control signals of a process controller. Alternatively, there have been attempts to determine the volumetric flow rate by indirect measurement, such as a pressure measurement in the heating channel and its ratio to a suction capacity of the suction ramp, as described in more detail in WO 2013/044968 A1. Even in the event of a more precise determination of the volumetric flow rate, however, proper functioning of the furnace according to a desired or ideal burning curve cannot be ensured when a heating channel cover is opened or improperly closed or a heating channel is clogged or blocked, for example.

Hence, in practice, volumetric flow rate assessment is performed by trained furnace personnel in the course of a tour of the furnace and/or by assessing status information of a process controller at regular time intervals. If a malfunction of the furnace caused, for example, by a blockage or a leak in the heating channel is detected, this blockage or leak is remedied manually by the furnace personnel. Since a tour of the furnace is carried out at time intervals of up to four hours, for example, dangerous operating states of the furnace which result from a blockage or a leak and which can lead to deflagrations, fires or explosions might not be recognized in time.

Hence, the object of the present invention is to propose a method for operating a furnace and a control device for a furnace by means of which an operation of the furnace can be improved.

This object is attained by a method having the features of claim 1, a control device having the features of claim 19, and a furnace having the features of claim 20.

In the method according to the invention for operating a furnace, in particular an anode furnace, the furnace is formed by a plurality of heating channels and furnace chambers, the furnace chambers serving to receive carbonaceous bodies, in particular anodes, and the heating channels serving to control the temperature of the furnace chambers, the furnace comprising at least one furnace unit, the furnace unit comprising a heating zone, a fire zone and a cooling zone, which for their part are formed by at least one section comprising furnace chambers, a suction ramp of the furnace unit being disposed in a section of the heating zone, and a burner ramp of the furnace unit being disposed in a section of the fire zone, combustion air or process air in the heating channels of the fire zone being heated by means of the burner ramp, and hot air or exhaust gas being suctioned from the heating channels of the heating zone by means of the suction ramp, an operation of the ramps being controlled by means of a control device of the furnace unit, wherein the control device is used to determine respective enthalpy flow rates for at least two sections, a difference of the respective enthalpy flow rates being determined as a characteristic, the characteristic thus determined being compared to a presupposed characteristic, a status of the furnace being determined based on the comparison.

The control device is used to determine an enthalpy flow rate of the respective sections; for example, the control device can calculate the enthalpy flow rate by means of a mathematical model. The term enthalpy flow rate refers to the enthalpy transported in the section in question during a unit of time, i.e., the enthalpy transported in the process air in the heating channels. Alternatively, the enthalpy flow rate can be easily calculated based on a ratio of respective pressures and respective volumetric flow rates in a plurality of heating channels. Since the sections are connected to each other in series, an enthalpy flow rate changes across consecutive sections in a flow direction, which also affects an operating state of the furnace. Consequently, the control device calculates the respective enthalpy flow rates for at least two sections and, in another step, a difference of the respective enthalpy flow rates. The difference or differences are determined as a characteristic, i.e., an actual characteristic; the characteristic can be the difference itself or only the sign resulting from the difference. Furthermore, the actual characteristic is compared to a presupposed characteristic, i.e., a target characteristic, which is present when the furnace operates normally. The term normal operation as used herein refers to an undisturbed operation, that is, an operation without blockages or leaks of the heating channels. If the actual characteristic deviates significantly from the target characteristic, the probability is high that an operating state of the furnace is disturbed by a leak and/or a blockage of a heating channel. If the characteristics do not differ significantly, normal operation of the furnace can be assumed.

The determination of the characteristics and the ratios can be easily calculated arithmetically or mathematically by means of a computer program product of the control device, for example. Thus, it is easy to determine whether a ratio of the respective characteristics corresponds to a presumed operating state of the furnace or a burning curve or deviates therefrom. In the event of a deviation, the leak and/or the blockage of a heating channel can lead to critical operating states of the furnace. This deviation can be signaled by the control device, for example, in order to inform the furnace personnel so that the furnace personnel can locate the issue or make manual adjustments outside of rotational furnace tours. The fact that an identification of a state of a heating channel or a status of the furnace is based solely on a comparison of mathematically determined process parameters is particularly advantageous. By using characteristics and thus not working with specific absolute values or limit values for process parameters, it becomes possible to reliably determine the status over a long period of time. Since no absolute values or limit values are used as parameters, the method is tolerant to an aging of the furnace and the accompanying changes in operating behavior, for example. Overall, an improved operation of the furnace can be ensured in this way while avoiding dangerous operating states. In particular, high emissions and high fuel consumption, which can result from malfunctions, can be avoided as well.

The control device can be used to calculate the enthalpy flow rate based on a ratio of a respective pressure, a respective temperature and a respective mass flow rate or volumetric flow rate in the heating channel. Known chemical properties of an exhaust gas or the process air can be taken into account. It is also advantageous if the enthalpy flow rate in the heating channel of the heating zone and/or the firing zone is determined. Since differences in the mass flow rates due to the burning process used may occur, these differences can be taken into account as well. In this way, mass flow rates in the heating channels of the zones mentioned above can each be determined separately. Thus, a differentiated view of the operating state in the respective zones of the furnace becomes possible. Also, the mass flow rate can be determined even more precisely if a change in density of air in the heating channel is calculated based on a temperature gradient across the respective sections or heating channels and this change in density is taken into account when determining the mass flow rate.

The control device can identify a blockage and/or a leak of the heating channel as a status of the furnace, in which case the control device can issue an alert and/or stop a fuel supply of the burner ramp. If no safe operating state can be established, the furnace can be put into a safe operating state by shutting down the primary fuel supply of the burner ramp or of burners of the burner ramp. Alternatively, a notification or an alert can be issued first once a leak or a blockage of the heating channel has been detected so that the furnace personnel can inspect the affected heating channel and remedy the malfunction, if possible.

A volumetric flow rate of the sections between the suction ramp and the cooling ramp can be determined by means of the control device based on a pressure measured in the heating channel or other physical parameters in the heating channel. This volumetric flow rate can be calculated by the control device by means of a mathematical model. For example, a pressure in the heating channel can be measured in each section and at the exit of the fire zone. Furthermore, the control device can be used to determine the volumetric flow rate in the heating channel based on a ratio of the suction capacity and the pressure in the suction ramp and a ratio of the suction capacity and the pressure in the heating channel. The respective ratios can be calculated separately and the volumetric flow rate can be derived therefrom. Furthermore, the control device can be used to calculate a consistency of the volumetric flow rate and the enthalpy flow rate; based on this calculation, potential amounts of false air of the heating channels can be determined. If the volumetric flow rate and the enthalpy flow rate deviate from a presupposed ratio, this, too, can point to a possible malfunction.

The control device can be used to determine an enthalpy flow rate for at least one position P at each of the sections; based on the comparison, a status of the heating channel, the section and/or the respective position P can be determined. Position P refers to a real or assumed location within a heating channel of a section. A section can have multiple positions Pn, for example, at each opening of the heating channel. For instance, the heating channel can be divided into 20 different positions P1 to P20. The control device classifies each position P as a balance area. Each balance area, i.e., each position P, has a flow inlet and a flow outlet, operating parameters being assigned to each position P. These operating parameters are actually measured or determined using a mathematical model. Since an operating parameter, such as a temperature, always depends on the upstream temperature in the flow direction of the process air in the heating channels, a change in temperature at a first position P1 in the flow direction causes a change in temperature at all downstream positions P1+n. This model of balancing operating parameters for each position P or of the respective enthalpy flow rates allows an even more precise determination of a status of the heating channel in question.

The control device can be used to determine an enthalpy flow rate of all positions Pn. While this is not absolutely necessary since not all positions P1 or branches of heating channels have to be included in determining the characteristics, it allows a more precise determination of a status of the respective heating channel. For example, it may be intended for a position P to be defined in each branch of a heating channel from a measuring ramp or a zero ramp to a suction ramp.

The control device can be used to determine a sum mass flow rate for the respective position P, preferably for all positions Pn of the furnace; the sum mass flow rate can be determined based on partial mass flow rates of a primary fuel, a secondary fuel, aspirated false air and/or an exhaust gas of the upstream position Pn−1. The control device can be used to measure or calculate the primary fuel and the secondary fuel. The false air aspirated at the respective position P is aspirated from the ambient air by a vacuum existing in the heating channel during regular operation of the furnace. This false air can be stored in the control device as a specification or an operating parameter for each position P. The control device can calculate the exhaust gas resulting from the burned amount of fuel based on the amount of fuel, i.e., the total amount of fuel. From these partial mass flow rates, the control device then calculates the sum mass flow rate for the respective position P, in particular taking into account the partial mass flow rates of the upstream position Pn−1. Overall, this makes it possible to determine respective sum mass flow rates for each position Pn of the heating channel across the length of the heating channel. The respective sum mass flow rates can be used, in turn, to determine a loss of pressure along the heating channel in question. In this way, a pressure difference between adjacent positions P can be determined. The respective pressures and mass flow rates determined for each of the positions Pn can thus be used to determine the enthalpy flow rate in a particularly precise manner.

A primary amount of fuel of the burner ramp can be determined by means of the control device, wherein a secondary amount of fuel of the heating zone and/or the burner zone can be determined as a function of at least one chemical property of the carbonaceous bodies by means of the control device. Fuel, such as gas or oil, is typically burned by means of the burner ramp or burners of the burner ramp, preferably multiple burner ramps. An amount of fuel consumed, i.e., burned, by the burner ramp during a time interval is then determined by means of the control device with respect to said time interval. The amount of fuel consumed by the burner ramp, i.e., a primary amount of fuel, can be determined by measuring using a quantity measuring device or the like, for example. The secondary amount of fuel can be a fuel amount of pitch contained in the carbonaceous bodies or raw anodes, for example. Pitch is typically used as a binder in a molding process of raw anodes. The pitch or pitch distillates can be released at a temperature between 200° C. and 600° C. Depending on the chemical composition of the carbonaceous body or the anode, it contains a greater or smaller amount of pitch, which is known in principle. Depending on the temperature of the individual anode or its heating behavior, a greater or smaller amount of pitch distillate can be released, which burns in the fire zone. This secondary amount of fuel in the form of pitch distillate or other substances contained in the raw anodes and usable as fuel results in a change in a ratio of the amount of fuel and the process air. Hence, it is advantageous for the control device to be able to determine the secondary amount of fuel. According to a particularly simple embodiment, this determination can take place based on an amount of pitch present in the raw anodes, for example. A continuous determination of the secondary amount of fuel can take place by determining the heating of the carbonaceous products and a release of combustible components depending thereon based on a thermodynamic mathematical model, for example.

The primary amount of fuel can be calculated by means of the control device as a function of a temperature measured in the heating channel of the fire zone and/or based on control values of the burner ramp. Thus, it is no longer necessary to determine an amount of fuel by means of quantity measuring devices, which are consequently unnecessary as well. In principle, it remains possible to determine the primary amount of fuel by direct recordal of pulse times for an oil or gas injection of individual burners. Since a temperature in the heating channel of the fire zone is measured anyway for operating a burner ramp, this temperature can be advantageously used by the control device for calculating the primary amount of fuel. This calculation can be performed using empirical values for fuel consumptions at certain temperatures measured in the fire zone, for example. For instance, the calculation can be performed based on a mathematical function of the primary amount of fuel and the temperature.

The secondary amount of fuel of the heating zone can be calculated or estimated as a function of a mass loss, a degree of coking and/or a temperature of the anodes or carbonaceous bodies. Consequently, the secondary amount of fuel can be calculated by the control device by means of a mathematical model. A heat content or a temperature of the carbonaceous bodies has an impact on the release of pitch distillates, for example, which means that a proportion of the primary amount of fuel released by the carbonaceous bodies during a time interval can be calculated by means of the control device when a chemical property of the carbonaceous bodies, such as a mass fraction of pitch, a dwell time of the carbonaceous bodies in the furnace, a temperature level of the carbonaceous bodies during this time interval, therefore a degree of coking and therefore also a mass loss are known. A temperature of carbonaceous bodies in different sections can be measured directly. Direct measuring of a temperature can also be performed on individual carbonaceous bodies as a reference measurement. The control device can store and recalculate these measured values for a carbonaceous body or anode depending on the position of the carbonaceous body in a section or zone so that the control device can continuously adjust a degree of coking for the carbonaceous body at hand and therefore a secondary amount of fuel represented by the carbonaceous body.

The control device can calculate the temperature of the carbonaceous bodies. In addition to directly measuring the temperature of the anodes or carbonaceous bodies by means of sensors or other measurement devices, the control device can also calculate the temperature of the carbonaceous bodies by means of a mathematical model. This calculation can take the temperatures in the heating channels of the furnace measured by the control device into account. Furthermore, the respective temperatures at the suction ramp, at the burner ramp and in heating channels of other sections can be measured. The control device can calculate the temperature of the respective carbonaceous bodies from these temperatures of the furnace, which are essentially measured simultaneously. This calculation can take other operating parameters of the furnace into account. The calculation can also be performed based on empirical values, which are represented by mathematical functions, for example. In this case, direct measuring of the temperature of the carbonaceous bodies is no longer required during regular operation of the furnace.

The control device can calculate a total amount of fuel from the primary amount of fuel and the secondary amount of fuel. In this way, the amounts of fuel supplied to the heating channels in the heating zone and in the fire zone can be determined more precisely, wherein the required ratios of these amounts of fuel to residual oxygen contained in the exhaust gas can be determined for optimal combustion. Consequently, a ratio of the process air and the amount of fuel can also be determined more precisely.

The control device can use a connecting channel at the suction ramp as a position P1, the heating channel at a measuring element for measuring the temperature upstream of the suction ramp as a position P7, the heating channel at a measuring ramp upstream of the measuring element as a position P10 and/or the heating channel at the burner ramp upstream of the measuring ramp as a position P13. The use of these positions P for determining the status of the heating channel suffices for determining said status relatively reliably.

The control device can calculate the difference of the enthalpy flow rates of positions P7 to P1, P10 to P7 and/or P13 to P10, respective ratios of the enthalpy flow rates of positions P1, P7 and/or P10 to P13, and the respective volumetric flow rates at positions P1, P7, P10 and/or P13 as characteristics. With the temperatures measured at these positions P or calculated and from the calculated sum mass flow rates, the control device can determine the respective enthalpy flow rates at these positions P, taking into account temperature-dependent substance characteristics of the process air, for example. The differences of the enthalpy flow rates or the volumetric flow rates of the respective positions P and their ratios can be used in a simple manner for determining the characteristics. For example, a normal state of the furnace or an undisturbed operation can be defined in that the differences of the enthalpy flow rates are always positive, a ratio of the enthalpy flow rates: position 10/position P13>position P7/position P30>position P1/position P13. Operating states deviating from the thus defined normal operation can then be defined as a malfunction.

The control device can calculate respective pressures in the heating channel for positions Pn−1 downstream of a zero pressure ramp as a position P20 upstream of the burner ramp. Since a pressure at the zero pressure ramp, i.e., position P20, is typically 0 Pa, a pressure drop can be calculated based thereon for the downstream positions Pn−1 without measuring this pressure drop at said positions Pn−1. Furthermore, the pressure in the individual positions Pn−1 can be used to determine respective volumetric flow rates or flow rates for said positions Pn−1.

A pressure and/or a temperature can be measured at the measuring ramp, and the control device can correct a calculated pressure and/or a temperature according to the measured pressure and/or the temperature. The measuring ramp which is located at position P10 can consequently be used to correct the calculated pressure and/or the temperature at the calculated position P10. For example, the control device can first calculate the pressure and/or the temperature at the measuring ramp, and the calculation can be repeated iteratively by parameter variation until a sufficient agreement between the measured and the calculated pressure/temperature at the measuring ramp is reached. The respective characteristics for the remaining positions P, at which no measurement is possible, can be determined even more precisely in this manner.

The control device can compare the characteristic determined by the control device with predefined signs of presupposed characteristics and/or ratios of presupposed characteristics; based on the comparison, the status of the heating channel can be determined. For example, a blockage in the heating channel between the measuring ramp and a sensor of a burner ramp can be determined if a difference of the enthalpy flow rates position P7— position P1 is negative and if a relation of the differences is position P7— position P1<position P13— position P10<position P10— position P7 and if a relation of the enthalpy flow rate ratios is position P10/position P13>position P1/position P13>position P7/position P13 and if the respective volumetric flow rates are position P7<position P1<position P10<position P13. If these conditions are met, the control device can identify a partial or total blockage between position P7 and position P13 and process it. Furthermore, the control device can identify a blockage in the heating channel between position 10 and a last burner ramp at position P15 if a difference of the enthalpy flow rates position P7— position P1 is negative and if a relation of the differences is position P7— position P1<position P13— position P10<position P10— position P7 and the respective volumetric flow rates are position P7<position P10<position P1<position P13. If all conditions are met, the control device determines the state of a partial or total blockage between the measuring ramp and the burner ramp in the heating channel. A leak in the heating channel in the area of the burner ramp or the burner ramps can be identified if a difference of the enthalpy flow rates position P7— position P1 is negative and if a relation of the differences is position P7— position P1<position P10— position P7<position—position P10 and if a relation of the enthalpy flow rate ratios is position P1/position P13>position P10/position P13>position P7/position P13. If these conditions are met, the control device can determine a leak in the heating channel as a state.

Furthermore, the control device can compare the characteristics determined by the control device with characteristics stored in the control device, the comparison allowing a probability of the status of the heating channel to be determined. The comparison with a standard situation enables the control device to determine and process the probability of the presence of a blockage or a leak in the heating channel in the range of 0 to 100%. This determined probability can be provided as information to the furnace personnel or can be processed for further transmission to a controller of the furnace, for example, for triggering an interruption of a fuel supply at the burner ramp.

The control device can take into account a loss of pressure in the heating channel and/or a potential amount of false air for each of the positions P of the heating zone and/or the firing zone as a function of a shape of the heating channel. The amount of false air can be calculated by the control device by means of a mathematical model. The amount of false air can be calculated iteratively, for example, based on empirical values represented by mathematical functions. The amount of air introduced into the heating channels can be determined at a fan ramp in the area of the cooling zone, for example. The amount of air at the fan ramp can be determined by determining a valve position of a throttle valve. A cross section of a suction channel can be varied by adjusting the throttle valve with the result that the amount of air introduced into the heating channels depends inter alia on the adjusted cross section of the suction channel. If a throttle valve or a similar feature of this kind is used, a suction capacity or an amount of air can therefore be deduced from a valve position, which is indicated in angular degrees relative to the suction channel, for example. The amount of air can be used by the control device to calculate the volumetric flow rate. Alternatively, an introduced amount of air can be determined by measuring the pressure in the heating channels between the fan ramp and the burner ramp. Furthermore, it is possible for an introduced amount of air to be determined via a speed of ventilators.

The control device can control the volumetric flow rate and/or the enthalpy flow rate. This control of the calculated volumetric flow rate or the enthalpy flow rate can take place taking other operating parameters, such as an amount of false air or other measured data, into account.

The volumetric flow rate, preferably of the sections and/or the suction ramp and/or the cooling ramp, and/or an introduced amount of air can be adjusted in such a manner by means of the control device that a target ratio of the process air and the primary amount of fuel and/or the secondary amount of fuel, preferably of the total amount of fuel, can be reached, the target ratio being defined in the control device. The control device can calculate an actual ratio of the process air and the amount of fuel and control it according to the target ratio by adjusting the introduced amount of air. To this end, the control in device can have one or multiple controllers, such as PID controllers. Thus, it is possible to ensure at all times that a ratio of the process air and the amount of fuel does not deviate to a point at which dangerous operating states arise. Also, a state which is optimal for a combustion of the different fuels can be established.

This adjustment can take place by a control of the volumetric flow rate at the suction ramp and/or the cooling ramp by means of the control device. This control of the volumetric flow rate can be accomplished by actuating throttle valves at the suction ramp and/or the cooling ramp. The control can act on a motor drive of the throttle valve or throttle valves with the result that the volumetric flow rate is influenced.

Furthermore, the primary amount of fuel introduced can be adjusted in such a manner by means of the control device that a target ratio of the process air and the total amount of fuel can be reached, the target ratio being defined in the control device. Consequently, controlling an actual ratio of the process air and the total amount of fuel by metering the amount of fuel at the burner ramp is possible as well. The primary amount of fuel can be controlled in connection with a control of the volumetric flow rate, in which case the control device can also establish a cascade control.

The control device according to the invention is configured to operate a furnace, in particular an anode furnace, the furnace being formed by a plurality of heating channels and furnace chambers, the furnace chambers serving to receive carbonaceous bodies, in particular anodes, and the heating channels serving to control the temperature of the furnace chambers, the furnace comprising at least one furnace unit, the furnace unit comprising a heating zone, a fire zone and a cooling zone, which for their part are formed by at least one section comprising furnace chambers, a suction ramp of the furnace unit ben ing disposed in a section of the heating zone, and a burner ramp of the furnace unit being disposed in a section of the fire zone, the burner ramp being configured to heat process air in the heating channels of the fire zone, and the suction ramp being configured to suction exhaust gas from the heating channels of the heating zone, the control device of the furnace unit being configured to control an operation of the ramps, wherein the control device is configured to determine an amount of fuel of the burner ramp, wherein the control device is configured to determine respective enthalpy flow rates for at least two sections, a difference in the respective enthalpy flow rates being determined as a characteristic, the characteristic thus determined being compared to a presupposed characteristic, a status of the furnace being determined based on the comparison. Reference is made to the description of advantages of the method according to the invention regarding the advantages of the control device according to the invention. Further advantageous embodiments of a control device are apparent from the description of features of the dependent claims referring to method claim 1.

The furnace, in particular the anode furnace, according to the invention comprises a control device according to the invention. Further embodiments of a furnace are apparent from the description of features of the depending claims referring to method claim 1.

Hereinafter, a preferred embodiment of the invention is explained in more detail with reference to the accompanying drawings.

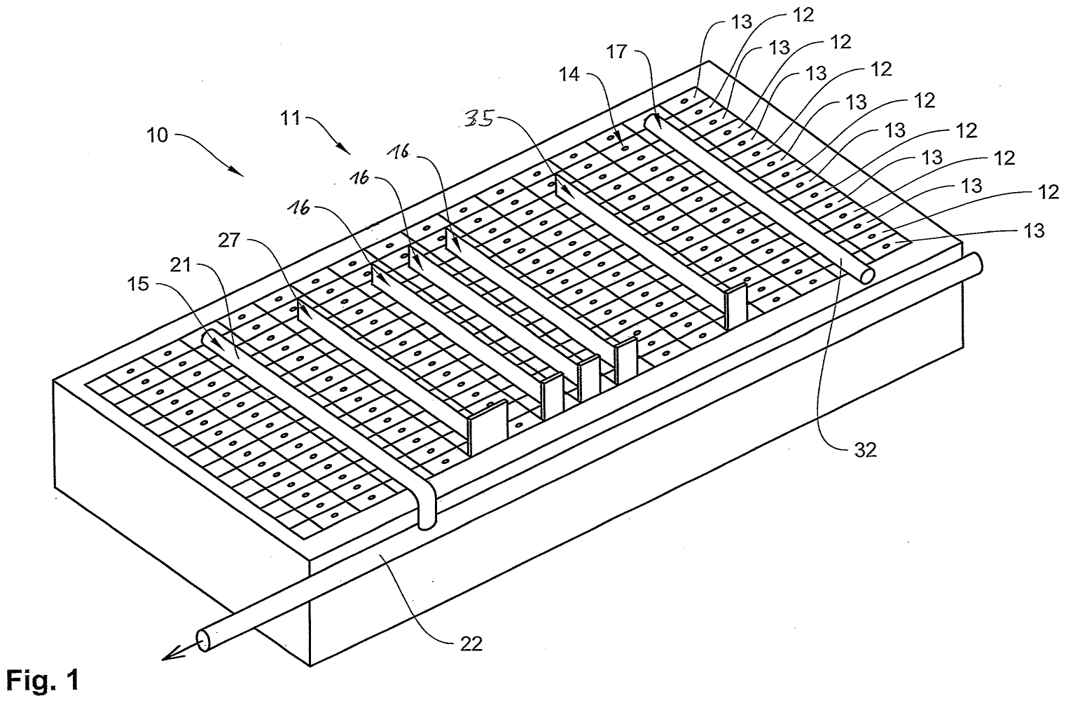

FIG. 1 is a schematic illustration of a furnace in a perspective view;

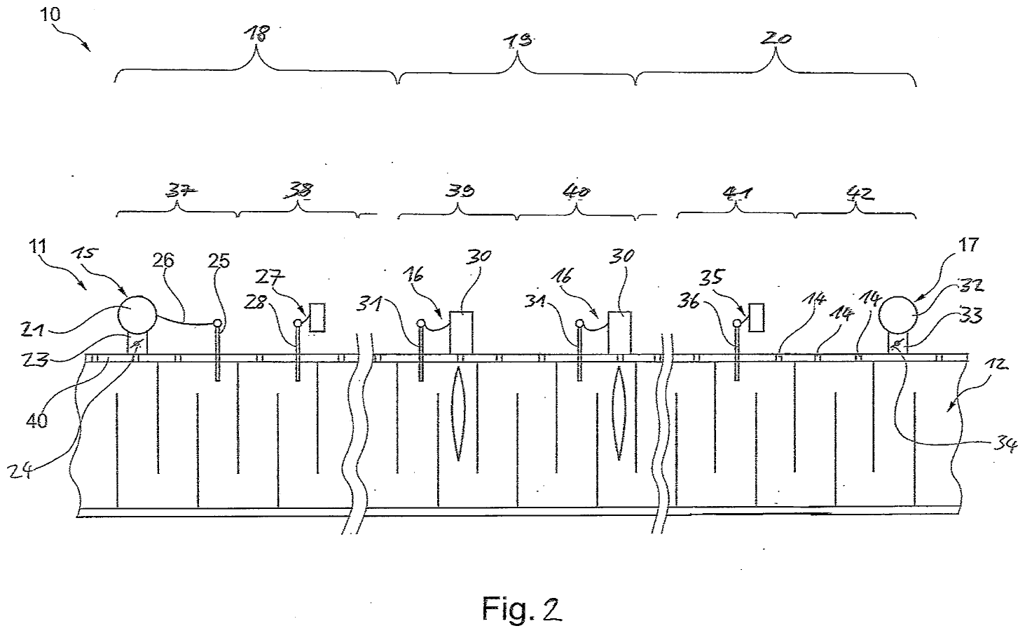

FIG. 2 is a schematic illustration of a furnace unit of the furnace in a longitudinal section view;

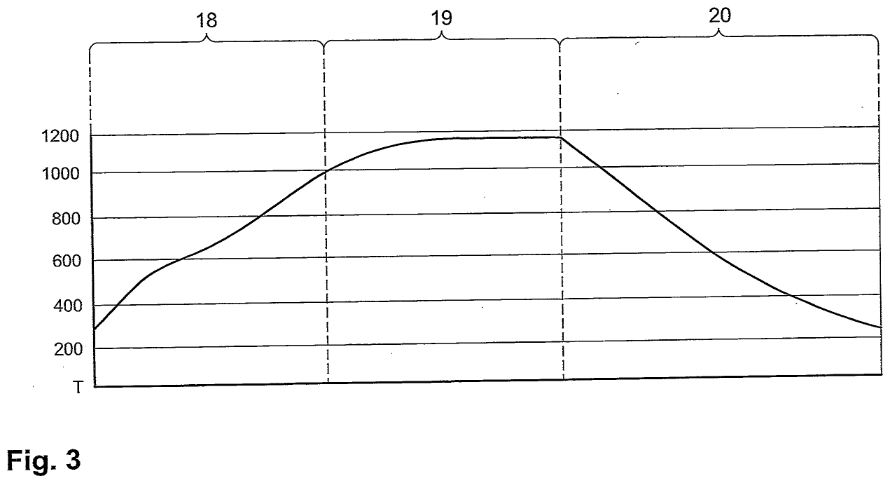

FIG. 3 shows a temperature distribution in the furnace unit;

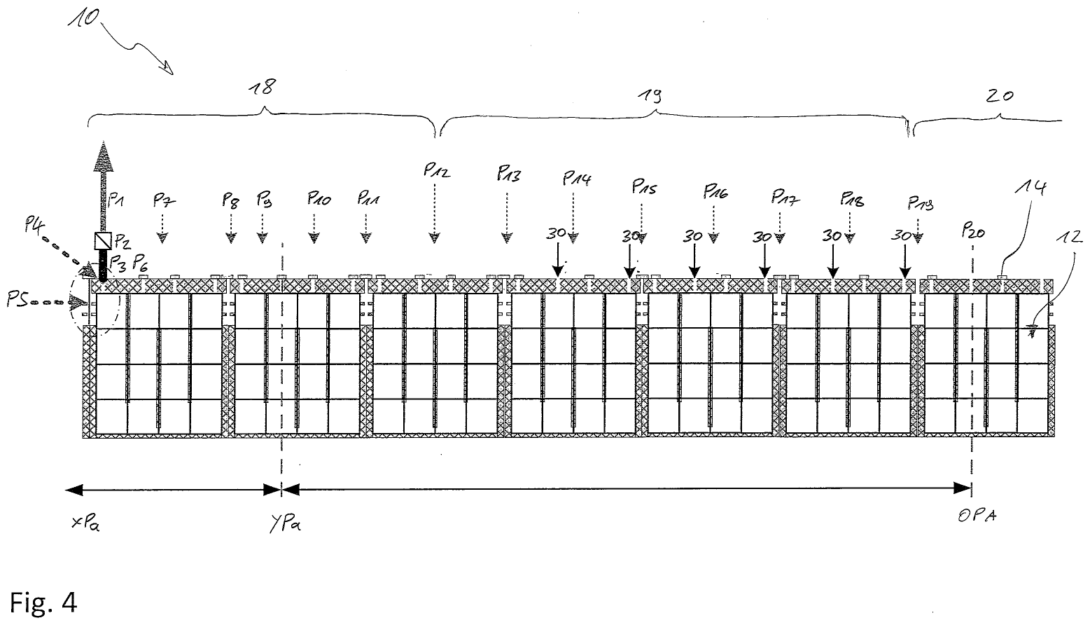

FIG. 4 is a partial illustration of the furnace unit of FIG. 2;

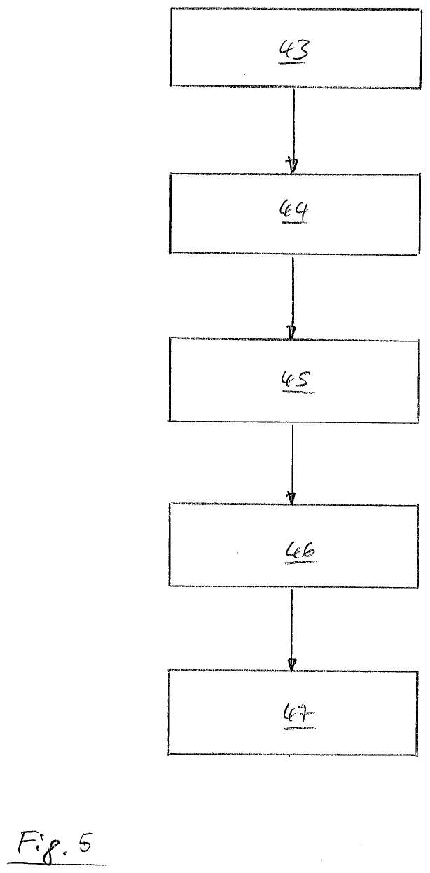

FIG. 5 is a process diagram for an embodiment of the method for operating a furnace.

A combined view of FIGS. 1 and 2 shows a schematic illustration of an anode furnace or furnace 10 comprising a furnace unit 11. Furnace 10 has a plurality of heating channels 12, which extend parallel to each other along interposed furnace chambers 13. Furnace chambers 13 serve to accommodate anodes or carbonaceous bodies (not shown).

Heating channels 12 extend in a meandering shape in the longitudinal direction of furnace 10 and have heating channel openings 14 at regular intervals, which are each covered by a heating channel cover (not shown).

Furnace unit 11 further comprises a suction ramp 15, one or multiple burner ramps 16 and a cooling ramp 17. Their positions on furnace 10 functionally define a heating zone 18, a fire zone 19 and a cooling zone 20, respectively. In the course of the production process of the anodes or carbonaceous bodies, furnace unit 11 is displaced in the longitudinal direction of furnace 10 relative to furnace chambers 13 or carbonaceous bodies by shifting suction ramp 15, burner ramps 16 and cooling ramp 17 with the result that all anodes or carbonaceous bodies located in anode furnace 10 pass through zones 18 to 20.

Suction ramp 15 is essentially formed by a collecting channel 21, which is connected to an exhaust gas cleaning system (not shown) via an annular channel 22. Collecting channel 21 for its part is connected to a heating channel opening 14 via a connecting channel 23 in each case, a throttle valve 24 being disposed on connecting channel 23 in the case at hand. Furthermore, a measuring element (not shown) for pressure measuring is disposed within collecting channel 21, and another measuring element 25 for temperature measuring is disposed in each heating channel 12 directly upstream of collecting channel 21 and is connected thereto via a data line 26. Moreover, a measuring ramp 27 comprising measuring elements 28 for each heating channel 12 is disposed in heating zone 18. A pressure and a temperature in the respective portion of heating channel 12 can be determined by means of measuring ramp 27.

Two to four, preferably three, burner ramps 16 comprising burners 30 and measuring elements 31 for each heating channel 12 are placed in fire zone 19. Burners 30 each burn a flammable fuel in heating channel 12, a burner temperature being measured by means of measuring elements 31. This makes it possible for a desired burner temperature to be set in the area of fire zone 19.

Cooling zone 20 comprises cooling ramp 17, which is formed by a feeding channel 32 comprising respective connecting channels 33 and throttle valves 34 for being connected to heating channels 12. Fresh air is blown into heating channels 12 via feeding channel 32. The fresh air cools heating channels 12 or the anodes or carbonaceous bodies located in furnace chambers 13 in the area of cooling zone 20, the fresh air continuously heating up until it reaches fire zone 19. In this context, FIG. 3 shows a diagram of the temperature distribution relative to the length of heating channel 12 and zones 18 to 20. Furthermore, a measuring ramp or what is referred to as a zero pressure ramp 35 comprising measuring elements 36 is disposed in cooling zone 20. Measuring elements 36 serve to detect a pressure in respective heating channels 12. The pressure in heating channel 12 is essentially 0 in the area of measuring elements 36, a high pressure forming between measuring elements 36 and cooling ramp 17, and a vacuum forming in heating channels 12 between measuring elements 36 and suction ramp 15. Consequently, the fresh air flows from cooling ramp 17 through heating channels 12 toward suction ramp 15. Ramps 15 to 17 are each disposed in sections 37 to 42, sections 37 to 42 for their part each being formed by heating channel portions 12. Sections adjacent to sections 37 to 42 are not shown for the sake of clarity of the figure.

FIG. 4 shows a partial illustration of furnace unit 11 of furnace 10, which has been illustrated in FIG. 2. In particular, an operation of furnace 10 or suction ramp 15, burner ramp 16 and cooling ramp 17 is controlled by means of a control device (not shown) of furnace unit 11, the control device comprising at least one means for data processing, such as a programmable logic controller or a computer, which is used to execute a computer program product or at least one software. The control device is used to determine an enthalpy flow rate for at least two of sections 37 to 42, a difference in the respective enthalpy flow rates being determined as a characteristic, the characteristic thus determined being compared to a presupposed characteristic, a status of furnace 10 or furnace unit 11 being determined based on the comparison.

In the example shown, positions P1 to P20 are defined at sections 37 to 41, positions P1 to P20 representing balance areas for which the control device determines an enthalpy flow rate and a volumetric flow rate. Positions P1 to P20 are distributed across furnace 10 in such a manner that possible systemic design features of the furnace influencing the enthalpy flow rate and the volumetric flow rate are taken into account. In particular, in the example shown, position P1 represents connecting channel 23, position P4 represents heating channel opening 14 for suction ramp 15, position P5 represents a seal of heating channel 12, position P7 represents measuring element 25 illustrated in FIG. 2, position P10 represents measuring element 28 illustrated in FIG. 2, positions P13 to P18 represent measuring element 31 and position P20 represents measuring element(s) 36. Burners 30 are positioned above positions P14 to P19. Position P20 thus corresponds to zero pressure ramp 35 and position P10 corresponds to measuring ramp 27. Positions P1 to P5 relate to suction ramp 15.

A value for a possible leak or false air is indicated in the control device for each of positions P1 to P20. The respective volumetric flow rates are determined with the actually measured or determined temperatures and pressures from the thus identified mass flow rates. The respective enthalpy flow rates of the process air can now be calculated from the known chemical properties of the process air and the mass flow rates. This takes place by means of the control device, which determines a primary amount of fuel of burner ramps 16. Furthermore, a temperature of the anodes or carbonaceous bodies (not shown) is calculated by means of the control device and a secondary amount of fuel of heating zone 18 is calculated based thereon by means of the control device as a function of at least one chemical property of the anodes or carbonaceous bodies. The control device calculates a total amount of fuel from the primary amount of fuel and the secondary amount of fuel.

Furthermore, a pressure is measured at a position P10 and at a position P20, the pressure difference then known being distributed among the remaining balance areas or positions P. A mass flow rate for the exhaust gas or the process air can now be calculated for each balance area or position P from the respective pressure differences, the temperature and the flow parameters. Respective sum mass flow rates are composed of the mass flow rates for the exhaust gas, the false air, the primary fuel and the secondary fuel. The sum mass flow rates thus determined for the balance areas in question allow a pressure loss for positions Pn−1 downstream of zero pressure ramp 35, i.e., position P20, in particular for position P10. The pressure and temperature values actually measured at position P10 can be compared to the calculated measuring values by the control device, an iterative repetition of the calculation by parameter variation allowing the calculation to be adapted to the actually measured values. The sum mass flow rate thus calculated for position P10 is again distributed across downstream positions P as described above and calculated for respective positions P taking into account false air etc. The resulting enthalpy flow rates and volumetric flow rates for respective positions P are then processed by means of the control device. In particular, a difference in the enthalpy flow rates and a ratio of the enthalpy flow rates and of the volumetric flow rates are calculated. These differences and ratios correspond to a characteristic, which can also be represented by a mathematical sign. Since the characteristics for a normal system state of furnace 10 or furnace unit 11 are known and stored in the control device, the control device compares the determined characteristics, i.e., the actual characteristics, to the presupposed characteristics, i.e., the characteristics for a normal system state. Depending on the result of the comparison, the control device can identify a blockage and/or a leak in the area of one of positions P1 to P20. When drawing the comparison to the presupposed characteristics, the control device can additionally determine a probability of the presence of this blockage or leak in a range of 0% to 100%. In particular, the control device is intended to identify blockages in heating channel 12 in sections 37 and 38 to measuring ramp 27, blockages in heating channel 12 between measuring ramp 27 and firing zone 19, leaks in heating channel 12 in the area of sections 37 and 38 and a general state of heating channel 12. If the control device identifies a blockage and/or a leak, it can proceed by issuing an alert and/or stop a fuel supply at burner ramps 16 of affected heating channel 12, which establishes a safe operating state of furnace 10.

FIG. 5 shows a schematic illustration of a process for identifying blockages and/or leaks in a furnace by means of the control device. In a step 43, respective enthalpy flow rates are determined for positions P1 to P20 as described above. In a subsequent step 44, a difference and a ratio of enthalpy flow rates of selected positions P are calculated. In step 45, the control device determines characteristics based on the calculation of the differences and ratios and correlates them. In step 46, these characteristics are compared to presupposed characteristics for a normal system state. The presupposed characteristics are stored in the control device. Subsequently, in step 47, the control device outputs a status of the furnace as a result of the comparison.

What is claimed is:

1. A method for operating a furnace including a plurality of heating channels and furnace chambers, the furnace chambers configured to receive carbonaceous bodies and the heating channels configured to control temperature of the furnace chambers, the furnace comprising at least one furnace unit,
wherein the at least one furnace unit includes a heating zone, a fire zone and a cooling zone, each of which is formed by at least one section comprising the furnace chambers,
wherein a suction ramp of the at least one furnace unit is disposed in a section of the heating zone, and a burner ramp of the at least one furnace unit is disposed in a section of the fire zone,
the method comprising:
heating process air in the heating channels of the fire zone by means of the burner ramp,
suctioning exhaust gas from the heating channels of the heating zone by means of the suction ramp,
wherein an operation of the burner ramp and the suction ramp is controlled by means of a control device of the furnace unit,
and further comprising:
with the control device,
determining respective enthalpy flow rates for at least two sections of the furnace unit
determining a characteristic representing a difference of the respective enthalpy flow rates,
comparing said characteristic to a presupposed characteristic, and
defining a status of the furnace based on a result of said comparing.

2. The method according to claim 1, wherein the determining a respective enthalpy flow rate of the respective enthalpy flow rates includes calculating said respective enthalpy flow rate from a ratio of
a respective pressure, a respective temperature, and a respective mass flow rate in a heating channel of the heating channels.

3. The method according to claim 1, comprising:
with the control device:
identifying a blockage and/or a leak of a heating channel of the heating channels as the status of the furnace, and
issuing an alert and/or stopping a fuel supply of the burner ramp.

4. The method according to claim 1,
further comprising:
with the control device, determining a volumetric flow rate of a section of the at least two sections of the furnace unit between a corresponding suction ramp and corresponding cooling ramp based on a pressure measured in a heating channel of the heating channels or other physical parameters in said heating channel.

5. The method according to any one of claims 1 to 4, comprising
with the control device,
determining an enthalpy flow rate for at least one position P of multiple positions P1, P2, . . . , P20 at each section, and
determining a status of the heating channel, said each section, and/or a respective position based on said comparing said characteristic to a presupposed characteristic.

6. The method according to claim 5, wherein said determining an enthalpy rate for at least one position P of multiple positions P1, P2, . . . , P20 at each section includes determining and enthalpy rate for each of twenty positions at each section.

7. The method according to claim 5,
comprising:
with the control device, determining a sum mass flow rate for the at least one position P from partial mass flow rates of a primary fuel, a secondary fuel, aspirated false air and/or an exhaust gas of a position Pn−1 located upstream with respect to the at least one position P.

8. The method according to claim 7, comprising:
with the control device, determining:
a primary amount of fuel of the burner ramp, and
a secondary amount of fuel of the heating zone and/or the burner zone as a function of at least one chemical property of the carbonaceous bodies.

9. The method according to claim 8, wherein
the primary amount of fuel is calculated as a function of a temperature measured in a heating channel of the fire zone and/or from control values of the burner ramp.

10. The method according to claim 8, wherein
the secondary amount of fuel of the heating zone is calculated as a function of a mass loss, a degree of coking and/or a temperature of the carbonaceous bodies.

11. The method according to claim 5,
comprising: defining, with the control device:
a connecting channel at the suction ramp as a position P1, a heating channel at a measuring element configured to measure temperature upstream of the suction ramp as a position P7, a heating channel at a measuring ramp upstream of said measuring element as a position P10, and/or a heating channel at the burner ramp upstream of said measuring ramp as a position P13.

12. The method according to claim 11, comprising:
determining, with the control device,
differences in enthalpy flow rates of positions P7 and P1, P10 and P7, and/or P13 and P10,
respective ratios of enthalpy flow rates of positions P1, P7 and/or P10 to an enthalpy flow rate of position P13, and
respective volumetric flow rates of positions P1, P7, P10 and/or P13
as respective characteristics.

13. The method according to claim 11, comprising:
calculating, with the control device, respective pressures in the heating channel for positions located downstream of a zero pressure ramp at a position P20 upstream of the burner ramp.

14. The method according to claim 13, comprising:

15. measuring a pressure and/or a temperature is measured at the measuring ramp, and
correcting a value of pressure and/or a value of temperature calculated with the control device according to a measured pressure and/or a measured temperature.

16. The method according to claim 5, comprising
comparing, with the control device, characteristics determined by the control device to predefined signs of presupposed characteristics and/or ratios of presupposed characteristics, and determining the status of the heating channel based on said comparing characteristics.

17. The method according to claim 5, comprising:
comparing, with the control device, characteristics determined by the control device to characteristics stored in the control device, and determining a probability of the status of the heating channel based on said comparing characteristics.

18. The method according to claim 5, comprising
assessing, with the control device, a loss of pressure in the heating channel and/or a potential amount of false air for the respective positions P of the heating zone and/or the firing zone as a function of a shape of the heating channel.

19. The method according to claim 1, comprising:
controlling, with the control device, a volumetric flow rate and/or an enthalpy flow rate of the respective enthalpy flow rates.

20. A control device for operating a furnace formed by a plurality of heating channels and furnace chambers, the furnace chambers configured to receive carbonaceous bodies, and the heating channels configured to control temperature of the furnace chambers, the furnace comprising at least one furnace unit, a furnace unit comprising a heating zone, a fire zone, and a cooling zone, each of which for their part are formed by at least one section comprising furnace chambers,
wherein a suction ramp of the furnace unit is disposed in a section of the heating zone, and a burner ramp of the furnace unit is disposed in a section of the fire zone,
wherein the burner ramp is configured to heat process air in heating channels of the fire zone, and the suction ramp is configured to suction exhaust gas from heating channels of the heating zone,
wherein the control device of the furnace unit is configured to control an operation of the suction ramp and the burner,
wherein the control device is configured
to determine respective enthalpy flow rates for at least two sections of the furnace unit, as a characteristic,
to compare said characteristic to a presupposed characteristic, and
to determine a status of the furnace based on comparison of said characteristic to the presupposed characteristic.

21. An anode furnace comprising a control device according to claim 19.
